(19) United States
(12) Patent Application Publication
(10) Pub. No.: US 2026/0097767 A1
(43) Pub. Date: Apr. 9, 2026

(54) VEHICLE CONTROL DEVICE AND VEHICLE CONTROL METHOD

(71) Applicants: DENSO CORPORATION, Kariya-city (JP); AISIN CORPORATION, Kariya (JP); ADVICS CO., LTD., Kariya-city (JP)

(72) Inventor: Kota KAGA, Tokyo (JP)

(21) Appl. No.: 19/414,983

(22) Filed: Dec. 10, 2025

Related U.S. Application Data
(63) Continuation of application No. PCT/JP2024/021110, filed on Jun. 11, 2024.

(30) Foreign Application Priority Data
Jun. 13, 2023 (JP) 2023-096925

(51) Int. Cl. B60W 30/18; B60W 10/04; B60W 10/18; B60W 30/06; B60W 60/00

(52) U.S. Cl. CPC B60W 30/18018; B60W 10/04; B60W 10/18; B60W 30/06; B60W 60/0013

(57) ABSTRACT

A vehicle control device is configured to control a driving force and a braking force, acquire performance information regarding performance of the vehicle, determine, as a compensation interval time, the longer of a drive response delay time and a brake response delay time, determine a required driving force and a required braking force such that a relationship in which the braking force is at least equal to or greater than the driving force is maintained in terms of the drive accuracy and the brake accuracy, and such that the driving force and the braking force each fall within the driving force range and the braking force range, and identify a required following time, which is an estimated time required from start of the response to the request for power until the required driving force and required braking force are achieved.

### CROSS REFERENCE TO RELATED APPLICATION

The present application is a continuation application of International Patent Application No. PCT/JP2024/021110 filed on Jun. 11, 2024 which designated the U.S. and claims the benefit of priority from Japanese Patent Application No. 2023-096925 filed on Jun. 13, 2023. The entire disclosures of all of the above applications are incorporated herein by reference.

### TECHNICAL FIELD

The present disclosure relates to a vehicle control device and a vehicle control method.

### BACKGROUND

A related art discloses a technique that attempts to alleviate discomfort experienced by occupants during automated parking control. The brake response delay time and engine response delay time are taken into consideration, and it is attempted to offset changes in vehicle driving force accompanying changes in actual idling speed.

### SUMMARY

According to an aspect of the present disclosure, a vehicle control device usable in a vehicle performing automated driving control includes at least one of (i) a circuit and (ii) a processor with a memory storing computer program code executable by the processor configured to: control a driving force generated by a drive device of the vehicle and a braking force generated by a braking device of the vehicle; acquire performance information regarding performance of the vehicle, the performance information including: a drive response delay time, which is a response delay time of the drive device to a request for power; a brake response delay time, which is a response delay time of the braking device to a request for power; a drive accuracy, which is a realization accuracy of the drive device with respect to the request for power; a brake accuracy, which is a realization accuracy of the braking device with respect to the request for power; a driving force range, which is a range of the driving force in which the drive device can reflect the request for power with a specified accuracy or higher; a braking force range, which is a range of the braking force in which the braking device can reflect the request for power with a specified accuracy or higher; a driving force rate, which is an amount of the driving force that the drive device can change per unit time; and a braking force rate, which is an amount of the braking force that the braking device can change per unit time; determine, as a compensation interval time, the longer of the drive response delay time and the brake response delay time acquired, the compensation interval time being time until the drive device and the braking device begin to respond to the request for power; determine, using the drive accuracy, the brake accuracy, the driving force range, and the braking force range acquired, a required driving force and a required braking force such that a relationship in which the braking force is at least equal to or greater than the driving force is maintained in terms of the drive accuracy and the brake accuracy, and such that the driving force and the braking force each fall within the driving force range and the braking force range, respectively; and identify, using the driving force rate and the braking force rate acquired and the required driving force and the required braking force determined, a required following time, which is an estimated time required from start of the response to the request for power until the required driving force and required braking force are achieved. The at least one of the circuit and the processor may maintain, at a time of vehicle start-up, the driving force required of the drive device and the braking force required of the braking device at the required driving force and the required braking force determined, until the compensation interval time and the subsequent required following time have elapsed.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an example of the schematic configuration of a vehicle system;

FIG. 2 is a diagram illustrating an example of the schematic configuration of a driving support ECU;

FIG. 3 is a diagram illustrating an example of the schematic configuration of a drive/brake force control unit;

FIG. 4 is a diagram for explaining an example of the overall flow during automated parking;

FIG. 5 is a flowchart illustrating an example of the control flow during automated parking in the driving support ECU;

FIG. 6 is a flowchart illustrating an example of the processing flow at vehicle start-up in the drive/brake force control unit; and

FIG. 7 is a diagram for explaining changes in drive/brake force at vehicle start-up under control by the drive/brake force control unit.

### DETAILED DESCRIPTION

In a related art, the response delay time of actuators such as the braking device and the drive device is taken into consideration. However, the time required from the initiation of actuator response to the realization of the required value is not considered. Furthermore, the accuracy of control in achieving this required value is also not considered. Therefore, in the technique of the related art, there is a possibility that changes in vehicle driving force accompanying changes in actual idling speed cannot be offset. Consequently, the technique disclosed in the related art may not be able to alleviate discomfort experienced by vehicle occupants. In particular, when starting from a stationary state, which is difficult to control, there is a possibility that occupants may experience a sensation of sudden acceleration.

The present disclosure provides a vehicle control device and a vehicle control method that make it possible to further suppress discomfort experienced by occupants with respect to automated driving control, even when automated driving control is performed during vehicle start-up.

According to one aspect of the present disclosure, a vehicle control device usable in a vehicle performing automated driving control is provided. The vehicle control device includes: a drive/brake force control unit configured to control a driving force generated by a drive device of the vehicle and a braking force generated by a braking device of the vehicle; a performance information acquisition unit configured to acquire performance information regarding performance of the vehicle, the performance information including: a drive response delay time, which is a response delay time of the drive device to a request for power; a brake response delay time, which is a response delay time of the braking device to a request for power; a drive accuracy, which is a realization accuracy of the drive device with respect to the request for power; a brake accuracy, which is a realization accuracy of the braking device with respect to the request for power; a driving force range, which is a range of the driving force in which the drive device can reflect the request for power with a specified accuracy or higher; a braking force range, which is a range of the braking force in which the braking device can reflect the request for power with a specified accuracy or higher; a driving force rate, which is an amount of the driving force that the drive device can change per unit time; and a braking force rate, which is an amount of the braking force that the braking device can change per unit time; a compensation interval time determination unit configured to determine, as a compensation interval time, the longer of the drive response delay time and the brake response delay time acquired by the performance information acquisition unit, the compensation interval time being time until the drive device and the braking device begin to respond to the request for power; a required drive/brake force determination unit configured to determine, using the drive accuracy, the brake accuracy, the driving force range, and the braking force range acquired by the performance information acquisition unit, a required driving force and a required braking force such that a relationship in which the braking force is at least equal to or greater than the driving force is maintained in terms of the drive accuracy and the brake accuracy, and such that the driving force and the braking force each fall within the driving force range and the braking force range, respectively; and a required following time identification unit configured to identify, using the driving force rate and the braking force rate acquired by the performance information acquisition unit and the required driving force and the required braking force determined by the required drive/brake force determination unit, a required following time, which is an estimated time required from start of the response to the request for power until the required driving force and required braking force are achieved. The drive/brake force control unit maintains, at a time of vehicle start-up, the driving force required of the drive device and the braking force required of the braking device at the required driving force and the required braking force determined by the required drive/brake force determination unit, until the compensation interval time and the subsequent required following time have elapsed.

According to one aspect of the present disclosure, a vehicle control method usable in a vehicle performing automated driving control is provided. The vehicle control method is executed by at least one processor. The vehicle control method includes: controlling a driving force generated by a drive device of the vehicle and a braking force generated by a braking device of the vehicle; acquiring performance information regarding performance of the vehicle, the performance information including: a drive response delay time, which is a response delay time of the drive device to a request for power; a brake response delay time, which is a response delay time of the braking device to the request for power; a drive accuracy, which is a realization accuracy of the drive device with respect to the request for power; a brake accuracy, which is a realization accuracy of the braking device with respect to the request for power; a driving force range, which is a range of the driving force in which the drive device can reflect the request for power with a specified accuracy or higher; a braking force range, which is a range of the braking force in which the braking device can reflect the request for power with a specified accuracy or higher; a driving force rate, which is an amount of the driving force that the drive device can change per unit time; and a braking force rate, which is an amount of the braking force that the braking device can change per unit time; determining, as a compensation interval time, the longer of the acquired drive response delay time and the acquired brake response delay time, the compensation interval time being a time until the drive device and the braking device begin to respond to the request for power; determining, using the acquired drive accuracy, the acquired brake accuracy, the acquired driving force range, and the acquired braking force range, a required driving force and a required braking force such that a relationship in which the braking force is at least equal to or greater than the driving force is maintained in terms of drive accuracy and brake accuracy, and such that the driving force and the braking force each fall within the driving force range and the braking force range, respectively; and identifying, using the acquired driving force rate and the acquired braking force rate and the determined required driving force and the determined required braking force, a required following time, which is an estimated time required from start of the response to the request for power until the required driving force and the required braking force are achieved. At a time of vehicle start-up, the driving force required of the drive device and the braking force required of the braking device are maintained at the determined required driving force and the determined required braking force, until the compensation interval time and the subsequent required following time have elapsed.

According to the above configuration, since the required driving force and required braking force are set such that, in terms of drive accuracy and brake accuracy, the braking force is maintained at least equal to or greater than the driving force, it becomes possible to continuously prevent the driving force from exceeding the braking force regardless of the realization accuracy of the drive device and the braking device. In addition, since the required driving force and required braking force are set to values that satisfy the condition that the driving force and braking force each fall within the driving force range and braking force range, respectively, the drive device and braking device can reflect the requirements with a specified accuracy or higher, making it even more certain that the driving force does not exceed the braking force. Furthermore, at the time of vehicle start-up, until the compensation interval time and the subsequent required following time have elapsed, the required driving force and required braking force are maintained at the above-mentioned required driving force and required braking force. Therefore, until the drive device and braking device are able to realize the requirements, the required driving force and required braking force are maintained as described above, making it possible to more reliably suppress unintended sudden movement of the vehicle. As a result, even when automated driving control is performed during vehicle start-up, it becomes possible to further suppress discomfort experienced by occupants with respect to the driving control.

Multiple embodiments for disclosure will be described with reference to the drawings. For convenience of explanation, among the multiple embodiments, portions having the same functions as those shown in the drawings used in previous explanations may be assigned the same reference numerals, and their descriptions may be omitted. Portions assigned the same reference numerals may refer to explanations in other embodiments.

### Embodiment 1

### Schematic Configuration of Vehicle System 1

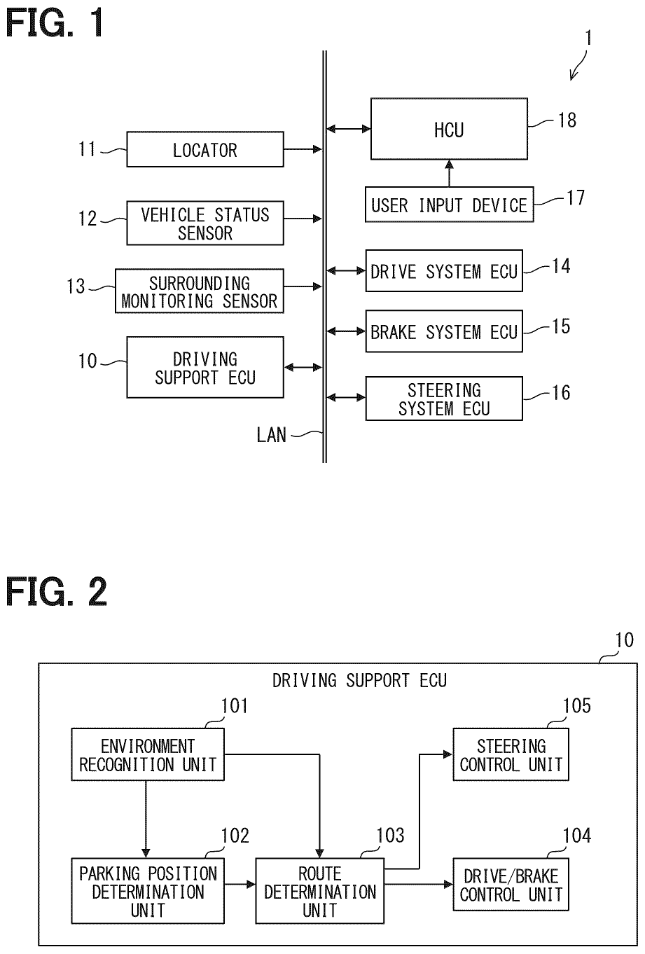

Hereinafter, Embodiment 1 of the present disclosure will be described with reference to the drawings. The vehicle system 1 shown in FIG. 1 can be used in a vehicle that performs automated driving control. Automated driving control may also be referred to as automated driving. As shown in FIG. 1, the vehicle system 1 includes a driving support ECU 10, a locator 11, a vehicle status sensor 12, a surrounding monitoring sensor 13, a drive system ECU 14, a braking system ECU 15, a steering system ECU 16, a user input device 17, and an HCU (Human Machine Interface Control Unit) 18. For example, the driving support ECU 10, the locator 11, the vehicle status sensor 12, the surrounding monitoring sensor 13, the drive system ECU 14, the braking system ECU 15, the steering system ECU 16, and the HCU 18 may be configured to be connected via an in-vehicle LAN (see LAN in FIG. 1). The vehicle using the vehicle system 1 is not necessarily limited to an automobile. However, in the following explanation, an automobile will be used as an example.

As for the stages of automated driving (also referred to as automation levels), for example, as defined by SAE, multiple levels may exist. The automation levels may be classified, for example, as LV0 to LV5 as follows. LV0 is a level in which the driver performs all driving tasks without system intervention. The driving tasks may also be referred to as dynamic driving tasks. The driving tasks include, for example, steering, acceleration/deceleration, and surrounding monitoring. LV0 corresponds to so-called manual driving. LV1 is a level in which the system assists with either steering or acceleration/deceleration. LV1 corresponds to so-called driving assistance. LV2 is a level in which the system assists with both steering and acceleration/deceleration. LV2 corresponds to so-called partial driving automation. Note that LV1 to LV2 are also considered part of automated driving.

For example, automated driving at LV1 to LV2 is defined as automated driving in which the obligation to monitor safe driving (simply referred to as the monitoring obligation) remains with the driver. In other words, it corresponds to automated driving with a monitoring obligation. The monitoring obligation includes visual monitoring of the surroundings. Automated driving at LV1 to LV2 can also be referred to as automated driving in which secondary tasks are not permitted. A secondary task refers to an act other than driving that is permitted to the driver and is a predetermined specific activity. Secondary tasks may also be referred to as secondary activities, other activities, etc. Secondary tasks must not interfere with the driver's ability to respond to a takeover request from the automated driving system. Examples of secondary tasks include viewing content such as videos, operating a smartphone or similar device, reading, eating, and other such activities.

Automated driving at LV3 is a level in which the system can perform all driving tasks under specific conditions, and the driver is required to operate the vehicle in emergencies. In LV3 automated driving, the driver must be able to respond promptly when a takeover request is issued by the system. This takeover can also be referred to as the transfer of the obligation to monitor the surroundings from the vehicle system to the driver. LV3 corresponds to so-called conditional driving automation. Automated driving at LV4 is a level in which the system can perform all driving tasks except under specific situations such as roads where operation is not possible or extreme environments. LV4 corresponds to so-called high driving automation. Automated driving at LV5 is a level in which the system can perform all driving tasks under any environment. LV5 corresponds to so-called full driving automation.

For example, automated driving at LV3 or higher is defined as automated driving in which the monitoring obligation does not rest with the driver. In other words, it corresponds to automated driving without a monitoring obligation. Automated driving at LV3 or higher can also be referred to as automated driving in which secondary tasks are permitted. The automated driving control of the present embodiment is assumed to be one in which the system performs at least acceleration and deceleration. The automated driving control of the present embodiment may be automated driving with a monitoring obligation or automated driving without a monitoring obligation. The automated driving control of the present embodiment is assumed to be automated driving control for automated parking. In the following, the automated driving control of the present embodiment will be described as one in which the system performs all driving tasks during automated parking.

The locator 11 is equipped with a GNSS (Global Navigation Satellite System) receiver and an inertial sensor. The GNSS receiver receives positioning signals from multiple positioning satellites. The inertial sensor includes, for example, a gyro sensor and an acceleration sensor. The locator 11 sequentially determines the vehicle position (also referred to as the own vehicle position) by combining the positioning signals received by the GNSS receiver with the measurement results from the inertial sensor. The configuration may also use the travel distance calculated from signals sequentially output from a vehicle speed sensor installed in the vehicle (also referred to as an own vehicle, or a subject vehicle) for determining the vehicle position. The vehicle position may be, for example, the center position of the rear axle of the vehicle, and may be represented as coordinates on an XY coordinate system with the X-axis and Y-axis defined in the horizontal plane.

The vehicle status sensor 12 is a group of sensors for detecting various states of the vehicle. Examples of the vehicle status sensor 12 include a vehicle speed sensor, a steering angle sensor, and a brake sensor. The vehicle speed sensor detects the speed of the vehicle. The steering angle sensor detects the steering angle, such as the steering angle or turning angle of the vehicle. The brake sensor detects whether the brake pedal is being depressed. As the brake sensor, a brake pedal force sensor that detects the pedal force applied to the brake pedal may be used. As the brake sensor, a brake stroke sensor that detects the amount of depression of the brake pedal may be used. As the brake sensor, a brake switch that outputs a signal corresponding to whether the brake pedal is being operated may also be used. The vehicle status sensor 12 outputs the detected sensing information to the in-vehicle LAN. The sensing information detected by the vehicle status sensor 12 may also be output to the in-vehicle LAN via an ECU installed in the vehicle.

The surrounding monitoring sensor 13 monitors the surrounding environment of the vehicle. A surrounding monitoring sensor may also referred to as a peripheral sensor. As one example, the surrounding monitoring sensor 13 detects obstacles around the vehicle, such as moving objects including pedestrians and other vehicles, and stationary objects such as fallen objects on the road. Additionally, it detects road markings such as lane lines around the vehicle. The surrounding monitoring sensor 13 may be, for example, a surrounding monitoring camera that images a predetermined area around the vehicle, or a probe wave sensor that transmits probe waves to a predetermined area around the vehicle. Examples of probe wave sensors include millimeter-wave radar, sonar, and LIDAR (Light Detection and Ranging/Laser Imaging Detection and Ranging). The predetermined area may include at least part of the front, rear, left, and right sides of the vehicle. The surrounding monitoring camera sequentially outputs the captured images as sensing information to the driving support ECU 10. The probe wave sensor sequentially outputs the scan results based on the received signals obtained when reflected waves are received from obstacles as sensing information to the driving support ECU 10.

The drive system ECU 14 and the braking system ECU 15 are electronic control units that perform acceleration and deceleration control. The drive system ECU 14 controls the drive unit of the vehicle. When the vehicle uses an internal combustion engine as the driving source, the drive system ECU 14 may be, for example, an engine ECU. When the vehicle uses a motor as the driving source, the drive system ECU 14 may be, for example, a power unit control ECU. The drive unit refers to the driving source of the vehicle. The braking system ECU 15 controls the brake system of the vehicle. The braking system ECU 15 may be, for example, a brake ECU. The brake system refers to the braking device. The steering system ECU 16 is an electronic control unit that performs steering control. The steering system ECU 16 controls the steering device of the vehicle. The steering system ECU 16 may be, for example, a steering ECU. The actuator for steering refers to the steering device.

The user input device 17 receives input from occupants of the vehicle. The user input device 17 may be an operation device that receives operational input from occupants. The operation device may be a mechanical switch or a touch switch integrated with a display device. Note that the user input device 17 is not limited to an operation device that receives operational input, as long as it is a device that receives input from occupants. For example, it may be a voice input device that receives voice command input from occupants. The user input device 17 is assumed to include an auto parking activation switch (also referred to as the AP switch). The AP switch is a switch that activates the automated parking function by the driving support ECU 10.

The HCU 18 is mainly configured as a computer comprising a processor, volatile memory, non-volatile memory, I/O, and a bus connecting these components. By executing a control program stored in the non-volatile memory, the HCU 18 performs various operations related to interaction between the occupants and the vehicle system. The HCU 18 acquires information on input received from occupants via the user input device 17.

The driving support ECU 10 is mainly configured as a computer comprising, for example, a processor, volatile memory, non-volatile memory, I/O, and a bus connecting these components. By executing a control program stored in the non-volatile memory, the driving support ECU 10 performs operations related to automated parking. The configuration of the driving support ECU 10 will be described in detail below.

### Schematic Configuration of Driving Support ECU 10

Next, the schematic configuration of the driving support ECU 10 will be described with reference to FIG. 2. As shown in FIG. 2, the driving support ECU 10 includes, as functional blocks, an environment recognition unit 101, a parking position determination unit 102, a route determination unit 103, a drive/brake control unit 104, and a steering control unit 105. Note that some or all of the functions executed by the driving support ECU 10 may be configured in hardware using one or more ICs or the like. Further, some or all of the functional blocks provided in the driving support ECU 10 may be realized by a combination of software executed by a processor and hardware components.

The environment recognition unit 101 recognizes the driving environment of the vehicle based on sensing information acquired from the surrounding monitoring sensor 13. The environment recognition unit 101 uses the sensing information from the surrounding monitoring sensor 13 to recognize the position, shape, and movement state of objects around the vehicle, and generates a virtual space that reproduces the actual driving environment. The environment recognition unit 101 may also recognize the positions of lane markings around the vehicle. The environment recognition unit 101 detects a parking space from the recognized driving environment. The parking space is an empty space where the vehicle can be parked. Whether a space is empty or not may be determined by the environment recognition unit 101 according to the size of the vehicle. As one example, the environment recognition unit 101 may detect an empty space located between or adjacent to obstacles as a parking space. Alternatively, the environment recognition unit 101 may detect an empty space between parking lines as a parking space.

The parking position determination unit 102 determines a target parking location for parking the vehicle in a parking space detected by the environment recognition unit 101. The target parking location may be determined so that the vehicle fits within the parking space. The parking position determination unit 102 may determine the parking space according to input received via the user input device 17. The parking space selected by the occupant from among the candidate parking spaces may be determined as the parking space.

The route determination unit 103 determines, as a route, a target trajectory along which the vehicle should travel to the target parking location determined by the parking position determination unit 102, while avoiding obstacles. The route determination unit 103 may repeatedly recalculate the target trajectory in response to changes in the situation.

The drive/brake control unit 104 determines the target vehicle speed and target acceleration for moving the vehicle along the route determined by the route determination unit 103. The drive/brake control unit 104 determines the drive/brake force that generates the determined target vehicle speed and target acceleration. The drive/brake force refers to the braking force and driving force. The term “drive/brake force” refers collectively to both braking force and driving force. The braking force and driving force may, for example, be expressed in units of N (newtons). The braking force is represented as a negative value, and the driving force is represented as a positive value. The drive/brake control unit 104 instructs the drive system ECU 14 and the braking system ECU 15 to generate the determined drive/brake force. As a result, the driving force generated by the driving source and the braking force generated by the brake device are controlled. The drive/brake control unit 104 determines and controls the drive/brake force when starting the vehicle from a stationary state. The drive/brake control unit 104 determines and controls the drive/brake force during travel after the vehicle has started. The drive/brake control unit 104 determines and controls the drive/brake force when stopping the vehicle. The processing performed by the drive/brake control unit 104 when starting the vehicle from a stationary state will be described in detail below. Hereinafter, the processing for starting the vehicle from a stationary state will be referred to as start-up process.

The steering control unit 105 determines the target steering angle for moving the vehicle along the route determined by the route determination unit 103. For example, the target steering angle may be determined at a point on the route that is ahead of the vehicle position by a response distance. The response distance may be defined as the distance estimated to be traveled by the vehicle during the response delay time of the steering control. The target steering angle is uniquely determined from the curvature of the route at the target point. The relationship between the route curvature and the target steering angle may be derived in advance through testing or the like. The steering control unit 105 instructs the steering system ECU 16 to achieve the determined target steering angle. As a result, the steering actuator is controlled to automatically change the steering angle of the vehicle.

### Schematic Configuration of Drive/Brake Control Unit 104

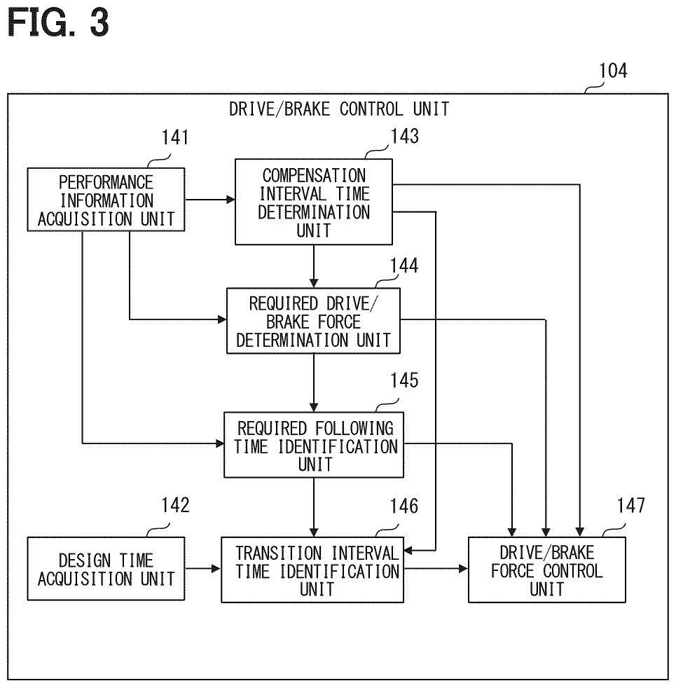

The schematic configuration of the drive/brake control unit 104 with respect to start-up process will be described with reference to FIG. 3. As shown in FIG. 3, the drive/brake control unit 104 includes, as functional blocks for start-up process, a performance information acquisition unit 141, a design time acquisition unit 142, a compensation interval time determination unit 143, a required drive/brake force determination unit 144, a required following time identification unit 145, a transition interval time identification unit 146, and a drive/brake force control unit 147. This drive/brake control unit 104 corresponds to the vehicle control device. In addition, execution of processing by each functional block of the drive/brake control unit 104 by a computer corresponds to execution of the vehicle control method.

The performance information acquisition unit 141 acquires performance information regarding the vehicle. The performance information may include information regarding the performance of actuators such as the braking device and the drive device of the vehicle. The performance information acquisition unit 141 may acquire performance information that has been previously stored in the non-volatile memory of the driving support ECU 10. The performance information may also be stored in non-volatile memory other than that of the driving support ECU 10. The performance information includes drive response delay time, brake response delay time, drive accuracy, brake accuracy, driving force range, braking force range, driving force rate, and braking force rate. The processing performed by the performance information acquisition unit 141 corresponds to the performance information acquisition step.

The drive response delay time is the response delay time of the drive device to a request for power. This power may be the driving force. The brake response delay time is the response delay time of the braking device to a request for power. This power may be the braking force. The drive accuracy is the realization accuracy of the drive device with respect to a request for power. That is, it is the range of error in the power actually generated by the drive device in response to a request for power. In other words, it is the range of error between the requested power and the actual power generated by the drive device. This power may be the driving force. The brake accuracy is the realization accuracy of the braking device with respect to a request for power. That is, it is the range of error in the power actually generated by the braking device in response to a request for power. This power may be the braking force. The driving force range is the range of driving force in which the drive device can reflect a request for power with a specified accuracy or higher. In other words, it is the range of driving force in which the drive device can accurately reflect a request for power. The specified accuracy may be arbitrarily defined. This power may be the driving force. The braking force range is the range of braking force in which the braking device can reflect a request for power with a specified accuracy or higher. In other words, it is the range of braking force in which the braking device can accurately reflect a request for power. This power may be the braking force. The driving force rate is the amount of driving force that the drive device can change per unit time. The braking force rate is the amount of braking force that the braking device can change per unit time. The units for the driving force rate and braking force rate may, for example, be expressed in N/sec.

The design time acquisition unit 142 acquires the design time, which is set as the preferred duration from the initiation of start-up control to the commencement of vehicle movement. The design time may be acquired by the design time acquisition unit 142 from information stored in advance in the non-volatile memory of the driving support ECU 10. The design time may be set according to a setting input received via the user input device 17. The design time may also be a predetermined fixed time. The design time may also be stored in non-volatile memory other than that of the driving support ECU 10. The timing at which control of the vehicle's start-up is initiated may be, for example, as follows. Hereinafter, the timing at which the control for starting the vehicle is initiated will be referred to as the start control initiation timing or the start-up control initiation timing. When the occupant's brake operation is required to maintain the stationary state before start-up, the start-up control initiation timing may be when the AP switch is turned on and also when the brake operation is released. When the occupant's brake operation is not required to maintain the stationary state before start-up, the start-up control initiation timing may be when the AP switch is turned on. The start-up control initiation timing may also be a timing other than those described above.

The compensation interval time determination unit 143 determines the compensation interval time. The compensation interval time is the period until the drive device and braking device begin to respond to a request for power. In other words, it is the time required for both the drive device and braking device to respond to a request for power. The compensation interval time determination unit 143 determines, as the compensation interval time, the longer of the drive response delay time and brake response delay time acquired by the performance information acquisition unit 141. The processing performed by the compensation interval time determination unit 143 corresponds to the compensation interval time determination step.

The required drive/brake force determination unit 144 determines the required driving force and required braking force using the drive accuracy, brake accuracy, driving force range, and braking force range acquired by the performance information acquisition unit 141. The required drive/brake force determination unit 144 determines the required driving force and required braking force that satisfy the following two conditions. The first condition is that, in terms of drive accuracy and brake accuracy, the relationship in which the braking force is greater than or equal to the driving force is maintained. In other words, even if the worst-case error indicated by the drive accuracy and brake accuracy is assumed, the relationship of braking force≥driving force is not violated. To enable start-up in accordance with the design time, it may be preferable that the first condition be such that the braking force is greater than the driving force in terms of drive accuracy and brake accuracy. That is, even if the worst-case error indicated by the drive accuracy and brake accuracy is assumed, the relationship of braking force>driving force is not violated. Hereinafter, the first condition will be described as a condition in which the relationship that the braking force is greater than the driving force in terms of drive accuracy and brake accuracy is maintained. The second condition is that the driving force and braking force each fall within the driving force range and braking force range, respectively. Specifically, the driving force falls within the driving force range, and the braking force falls within the braking force range. In other words, it is a condition in which both the drive device and braking device operate within regions where they can accurately reflect requests for power. The processing performed by the required drive/brake force determination unit 144 corresponds to the required drive/brake force determination step.

The required drive/brake force determination unit 144 may also determine the required driving force and required braking force so as to satisfy the above two conditions even when disturbances such as road gradients are present. In this case, for the first condition, the required drive/brake force determination unit 144 may determine values that satisfy the first condition even when the driving force or braking force generated by the disturbance is taken into account. The driving force or braking force generated by the disturbance may be identified by the required drive/brake force determination unit 144 using, for example, a map that defines in advance the correspondence between road gradients and drive/brake force. The road gradient may be identified from the vehicle's inclination sensor. The road gradient may also be identified from high-precision map data. High-precision map data refers to map data that is more precise than the map data used for route guidance in navigation functions. High-precision map data includes, for example, information usable for automated driving, such as three-dimensional road shape information, lane count information, and information indicating the permitted direction of travel for each lane.

The required following time identification unit 145 identifies the required following time. The required following time is the time estimated to be required from the start of the response of the drive device and braking device to a request for power until the required driving force and required braking force are achieved. In other words, it is the time estimated to be required from the start of the response of the drive device and braking device to a request for power until the actual driving force and braking force reach the required driving force and required braking force. The required following time identification unit 145 identifies the required following time using the driving force rate, braking force rate, required driving force, and required braking force. The required following time identification unit 145 uses the driving force rate and braking force rate acquired by the performance information acquisition unit 141. The required following time identification unit 145 uses the required driving force and required braking force determined by the required drive/brake force determination unit 144. For example, the required following time may be identified as follows. The required following time identification unit 145 calculates the drive following time by dividing the required driving force by the driving force rate. The required following time identification unit 145 calculates the brake following time by dividing the required braking force by the braking force rate. Then, the required following time identification unit 145 identifies, as the required following time, the longer of the drive following time and the brake following time. The processing performed by the required following time identification unit 145 corresponds to the required following time identification step.

The transition interval time identification unit 146 identifies the control transition interval time. The transition interval time identification unit 146 identifies the control transition interval time as the time obtained by subtracting the compensation interval time and the required following time from the design time. That is, control transition interval time=design time−(compensation interval time+required following time). The design time acquired by the design time acquisition unit 142 is used. The compensation interval time identified by the compensation interval time determination unit 143 is used. The required following time identified by the required following time identification unit 145 is used. The control transition interval time can also be described as the period from the end of the required following time until the design time is reached.

The drive/brake force control unit 147 controls the driving force generated by the drive device of the vehicle and the braking force generated by the braking device of the vehicle. The drive/brake force control unit 147 controls the driving force generated by the drive device through instructions to the drive system ECU 14. The drive/brake force control unit 147 controls the braking force generated by the braking device through instructions to the braking system ECU 15.

At the time of starting the vehicle, the drive/brake force control unit 147 controls the required drive/brake force in the following manner until both the compensation interval time and the subsequent required following time have elapsed. The drive/brake force control unit 147 maintains the required drive/brake force at the required driving force and required braking force determined by the required drive/brake force determination unit 144. The required drive/brake force refers to the driving force required of the drive device and the braking force required of the braking device. The processing performed by the drive/brake force control unit 147 corresponds to the drive/brake force control step. Here, the start-up of the vehicle refers to the start of the vehicle from a temporary stop in front of the parking location during automated parking, heading toward the parking location.

According to the above configuration, the required driving force and required braking force are set to values that maintain the relationship in which, in terms of drive accuracy and brake accuracy, the braking force is at least equal to or greater than the driving force. Therefore, regardless of the realization accuracy of the drive device and braking device, it is possible to continuously prevent the driving force from exceeding the braking force. Furthermore, the driving force and braking force that satisfy the condition that the driving force and braking force each fall within the driving force range and braking force range are set as the required driving force and required braking force. Thus, the drive device and braking device can reflect the request with the specified accuracy or higher, and it becomes even more certain that the driving force will not exceed the braking force. Additionally, at the time of vehicle start-up, until the compensation interval time and the subsequent required following time have elapsed, the required driving force and braking force are maintained at the above mentioned required driving force and required braking force. Therefore, until the drive device and braking device can realize the request, the required driving force and required braking force are maintained, thereby more reliably suppressing unintended vehicle movement. As a result, even when automated driving control is performed at vehicle start-up, it is possible to further reduce any sense of discomfort experienced by the occupant regarding the driving control. At the time of vehicle start-up during automated parking, there is a high possibility that many obstacles such as other vehicles exist in the vicinity of the vehicle. Therefore, there is a strong demand to suppress unintended vehicle movement and to reduce occupant discomfort with the driving control. Accordingly, these effects are particularly significant during vehicle start-up in automated parking.

It may be preferable that the drive/brake force control unit 147 controls the required drive/brake force as follows from the start to the end of the control transition interval time. The drive/brake force control unit 147 preferably varies the required driving force and braking force so that the sum of the driving force and braking force gradually transitions to zero in a stepwise manner. The period from the start to the end of the control transition interval time can be described as the time from the elapse of the required following time until the design time is reached. The required braking force determined by the required drive/brake force determination unit 144 exceeds the required driving force. Therefore, until the required following time, during which the required braking force and required driving force are maintained, has elapsed, the sum of the driving force and braking force is a negative value. In contrast, according to the above configuration, it becomes possible to actually start the vehicle at the timing when the design time is reached. Furthermore, since the required driving force and braking force are varied so that the sum of the driving force and braking force transitions stepwise to zero, it is possible to suppress unintended vehicle movement. As a result, even when automated driving control is performed at vehicle start-up, it is possible to further suppress any sense of discomfort experienced by the occupant regarding the driving control.

When the drive/brake force control unit 147 varies the required driving force and braking force so that the sum of the driving force and braking force transitions stepwise to zero, it may be preferable to control as follows using drive accuracy and brake accuracy. The drive/brake force control unit 147 preferably varies the value (either driving force or braking force) on the side with higher realization accuracy among the driving force and braking force, while maintaining the value on the side with lower realization accuracy. For example, if the drive accuracy is higher than the brake accuracy, the driving force is varied while the braking force is maintained. Conversely, if the brake accuracy is higher than the drive accuracy, the braking force is varied while the driving force is maintained. As a result, unintended vehicle movement caused by the power with lower realization accuracy can be suppressed even more reliably.

### Flow of Automated Parking

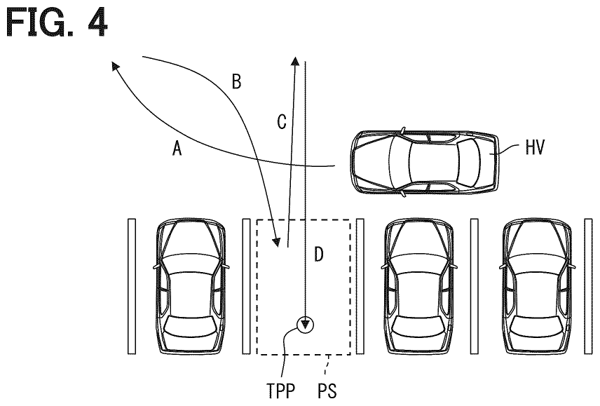

An example of the overall process during automated parking will be described with reference to FIG. 4. In FIG. 4, HV indicates the vehicle. PS in FIG. 4 indicates the parking space. TPP in FIG. 4 indicates the target parking location. A, B, C, and D in FIG. 4 represent the steps involved in automated parking.

As shown in FIG. 4, automated parking starts, for example, from a state in which the vehicle is stopped near the parking section. The stop may be performed by manual driving by the occupant of the vehicle. The stop may be performed manually by the occupant of the vehicle. That is, the configuration may be such that the stop is performed by the occupant's brake operation. Alternatively, the stop may be performed by the system through automated driving. When automated parking starts, the vehicle HV is moved forward for vehicle posture adjustment (see A in FIG. 4). During vehicle posture adjustment, the vehicle HV moves forward while turning to achieve a posture that allows entry into the parking space PS in reverse. Next, the vehicle HV is moved in reverse to enter the parking space PS (see B in FIG. 4).

Thereafter, the vehicle HV is moved forward for repositioning so that the vehicle position matches the target parking location TPP (see C in FIG. 4). Finally, the vehicle HV is moved in reverse to align the vehicle position with the target parking location TPP (see D in FIG. 4).

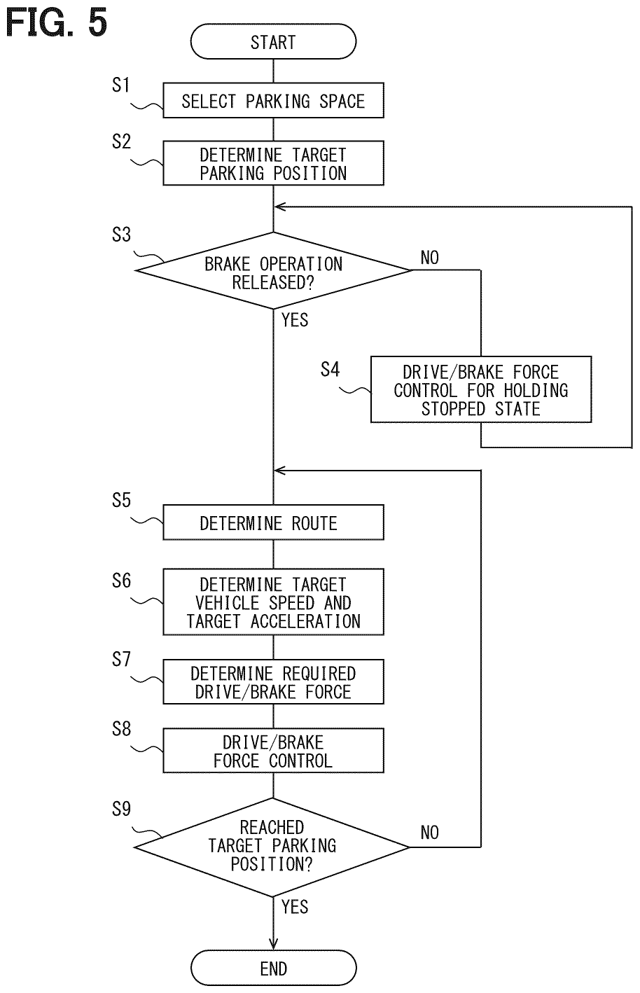

An example of the control flow during automated parking in the driving support ECU 10 will be described with reference to the flowchart in FIG. 5. In the example of FIG. 5, the case where the occupant's brake operation is required to maintain the stationary state before start-up is described. The flowchart in FIG. 5 may be configured to start when, for example, the AP switch is turned on while the vehicle is stopped near the parking section. Here, for convenience, the description of steering control is omitted, and the description focuses on drive/brake force control.

In step S1, the parking position determination unit 102 receives the selection of a parking space in which to park the vehicle. The parking position determination unit 102 may determine the parking space according to input received from the occupant via the user input device 17. For example, the occupant may select a parking space from among candidate parking spaces displayed on the vehicle display. In step S2, the parking position determination unit 102 determines the target parking location within the parking space selected in S1.

In step S3, if the brake operation by the occupant is released (YES in S3), the process proceeds to step S5. On the other hand, if the brake operation by the occupant is not released (NO in S3), the process proceeds to step S4. Whether the brake operation has been released can be determined by the driving support ECU 10 based on sensing information from the brake sensor. In this embodiment, the timing at which the brake operation is released is used as the start timing of control for starting the vehicle.

In step S4, the drive/brake control unit 104 performs drive/brake force control for holding the vehicle stationary. Then, the process returns to step S3 and repeats. In the drive/brake force control for holding the vehicle stationary, the drive/brake control unit 104 generates the drive/brake force necessary to maintain the vehicle stop, supplementing the braking force provided by the brake operation. That is, the drive/brake force is generated to compensate for any shortfall in the braking force required by the brake operation to maintain the stop.

In step S5, the route determination unit 103 determines the route for automated parking to the target parking location determined in S2. The route determination unit 103 may continuously update the target trajectory in response to changes in the situation. In step S6, the drive/brake control unit 104 determines the target vehicle speed and target acceleration for moving the vehicle along the route determined in S5. In step S7, the drive/brake control unit 104 determines the required drive/brake force to generate the target vehicle speed and target acceleration determined in S6.

In step S8, the drive/brake control unit 104 performs control to generate the required drive/brake force determined in S7. In step S9, if the vehicle has reached the target parking location (YES in S9), the process ends. Otherwise, if the vehicle has not reached the target parking location (NO in S9), the process returns to S5 and repeats.

### Start-Up Process in Drive/Brake Control Unit 104

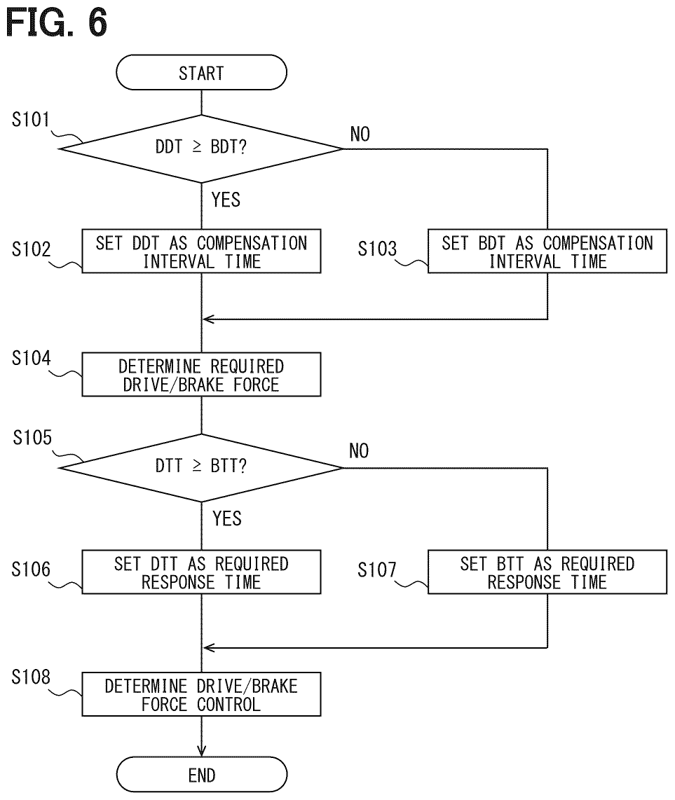

An example of the flow of start-up process in the drive/brake control unit 104 will be described with reference to the flowchart in FIG. 6. The flowchart in FIG. 6 may be configured to start when the brake operation by the occupant is released. In FIG. 6, the drive response delay time is indicated as DDT, and the brake response delay time is indicated as DBT. In FIG. 6, the drive following time is indicated as DTT, and the brake following time is indicated as BTT.

In step S101, if the drive response delay time is greater than or equal to the brake response delay time (YES in S101), the process proceeds to step S102.

On the other hand, if the drive response delay time is shorter than the brake response delay time (NO in S101), the process proceeds to step S103. The drive response delay time and the brake response delay time are acquired by the performance information acquisition unit 141. The comparison between the drive response delay time and the brake response delay time may be performed by the compensation interval time determination unit 143.

In step S102, the compensation interval time determination unit 143 determines the drive response delay time as the compensation interval time, and the process proceeds to step S104. In step S103, the compensation interval time determination unit 143 determines the brake response delay time as the compensation interval time, and the process proceeds to step S104. In step S104, the required drive/brake force determination unit 144 determines the required driving force and the required braking force that satisfy the two aforementioned conditions.

In step S105, the required following time identification unit 145 calculates the drive following time and brake following time. If the drive following time is greater than or equal to the brake following time (YES in S105), the process proceeds to step S106. On the other hand, if the drive following time is shorter than the brake following time (NO in S105), the process proceeds to step S107. The comparison between the drive following time and the brake following time may be performed by the required following time identification unit 145.

In step S106, the required following time identification unit 145 identifies the drive following time as the required following time, and the process proceeds to step S108. In step S107, the required following time identification unit 145 identifies the brake following time as the required following time, and the process proceeds to step S108. In step S108, the drive/brake force control unit 147 controls the drive/brake force according to the passage of time. The drive/brake force control unit 147 maintains the required driving force and the required braking force determined in S104 until the compensation interval time and the subsequent required following time have elapsed. After the required following time has elapsed and until the design time is reached, the drive/brake force control unit 147 gradually adjusts the drive/brake force so that the sum of the driving force and braking force transitions stepwise to zero. When the sum of the driving force and braking force reaches zero, the vehicle begins to move.

### Change in Drive/brake Force During Start-up Control by Drive/Brake Control Unit 104

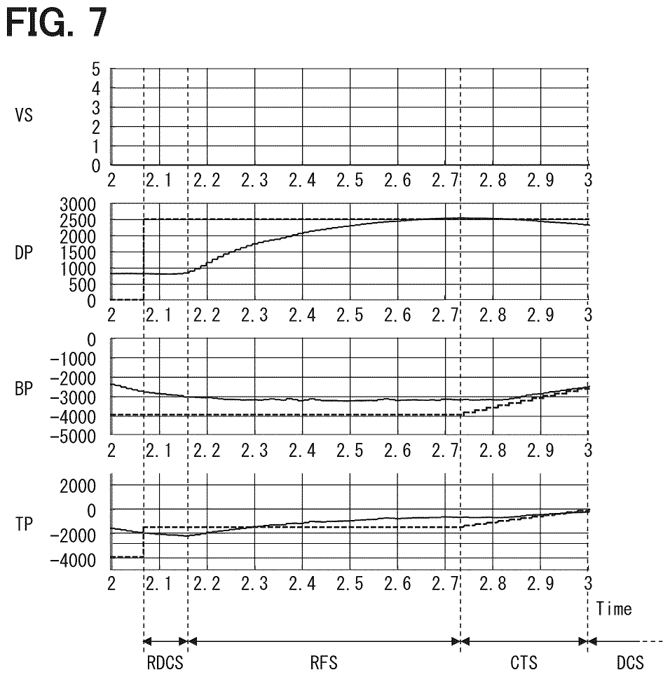

The change in drive/brake force during start-up control by the drive/brake control unit 104 will be described with reference to the graph in FIG. 7. In FIG. 7, the case where the drive accuracy is lower than the brake accuracy is described as an example. The horizontal axis of the graph in FIG. 7 represents time. VS in FIG. 7 indicates the time variation of the vehicle's speed. DP in FIG. 7 indicates the time variation of the vehicle's driving force. BP in FIG. 7 indicates the time variation of the vehicle's braking force. TP in FIG. 7 indicates the time variation of the sum of the vehicle's driving force and braking force (also referred to as the combined value). The solid line in FIG. 7 indicates the actual value, and the dashed line indicates the required value. RDCS in FIG. 7 indicates the compensation interval time. RFS in FIG. 7 indicates the required following time. CTS in FIG. 7 indicates the control transition interval time. DCS in FIG. 7 indicates the running control interval time. The running control interval time refers to the period during which the vehicle is being driven under running control after the vehicle has started moving.

As shown in FIG. 7, the vehicle speed remains zero from the start of start-up control until actual start-up. The timing of the start of start-up control is the same as the start timing of the compensation interval time. The timing of start-up is the same as the start timing of the running control interval time. As shown in FIG. 7, even when start-up control is initiated, control is performed so that the braking force exceeds the driving force, thereby maintaining the stationary state. As shown in FIG. 7, until the compensation interval time and the subsequent required following time have elapsed, the required driving force and required braking force are maintained at the aforementioned required driving force and required braking force. That is, the stationary state is maintained until both the driving force and braking force can be controlled accurately. During the control transition interval time after the required following time has elapsed, the required driving force and required braking force are adjusted so that the sum of the driving force and braking force gradually transitions to zero. That is, after both the driving force and braking force can be controlled accurately, they are gradually changed to the driving force and braking force required for the vehicle to start moving. At this time, as shown in FIG. 7, the driving force, which has lower control accuracy, is maintained, and the braking force, which has higher control accuracy, is varied. This makes it possible to start the vehicle while more reliably suppressing unintended vehicle movement.

### Embodiment 2

In Embodiment 1, an example was given in which the driving support ECU 10 recognizes the driving environment of the vehicle. However, this is not the only possible configuration. For example, the configuration may be such that an ECU other than the driving support ECU 10 recognizes the driving environment of the vehicle. In this case, the driving support ECU 10 may be configured to acquire information regarding the driving environment recognized by the ECU other than the driving support ECU 10.

### Embodiment 3

In Embodiment 1, the control of drive/brake force during vehicle start-up in automated parking was described; however, this is not necessarily limiting. For example, similar control may be performed for the control of drive/brake force during start-up in automated driving control not limited to automated parking.

It should be noted that the present disclosure is not limited to the embodiments described above, and various modifications can be made within the scope set forth in the disclosure. Embodiments obtained by appropriately combining the technical means disclosed in different embodiments are also included within the technical scope of the present disclosure. Furthermore, the control unit and its methods described in the present disclosure may be implemented by a dedicated computer comprising a processor programmed to execute one or more functions embodied by a computer program. Alternatively, the apparatus and methods described in the present disclosure may be implemented by dedicated hardware logic circuits. Alternatively, the apparatus and methods described in the present disclosure may be implemented by one or more dedicated computers including a combination of a processor executing a computer program and one or more hardware logic circuits. In addition, the computer program may be stored on a computer-readable non-transitory tangible recording medium as instructions to be executed by a computer.

What is claimed is:

1. A vehicle control device usable in a vehicle performing automated driving control, the vehicle control device comprising
at least one of (i) a circuit and (ii) a processor with a memory storing computer program code executable by the processor configured to:
control a driving force generated by a drive device of the vehicle and a braking force generated by a braking device of the vehicle;
acquire performance information regarding performance of the vehicle, the performance information including
a drive response delay time, which is a response delay time of the drive device to a request for power,
a brake response delay time, which is a response delay time of the braking device to a request for power,
a drive accuracy, which is a realization accuracy of the drive device with respect to the request for power,
a brake accuracy, which is a realization accuracy of the braking device with respect to the request for power,
a driving force range, which is a range of the driving force in which the drive device can reflect the request for power with a specified accuracy or higher,
a braking force range, which is a range of the braking force in which the braking device can reflect the request for power with a specified accuracy or higher,
a driving force rate, which is an amount of the driving force that the drive device can change per unit time, and
a braking force rate, which is an amount of the braking force that the braking device can change per unit time;
determine, as a compensation interval time, the longer of the drive response delay time and the brake response delay time acquired, the compensation interval time being time until the drive device and the braking device begin to respond to the request for power;
determine, using the drive accuracy, the brake accuracy, the driving force range, and the braking force range acquired, a required driving force and a required braking force such that a relationship in which the braking force is at least equal to or greater than the driving force is maintained in terms of the drive accuracy and the brake accuracy, and such that the driving force and the braking force each fall within the driving force range and the braking force range, respectively; and
identify, using the driving force rate and the braking force rate acquired and the required driving force and the required braking force determined, a required following time, which is an estimated time required from start of the response to the request for power until the required driving force and required braking force are achieved,
wherein
the at least one of the circuit and the processor is configured to maintain, at a time of vehicle start-up, the driving force required of the drive device and the braking force required of the braking device at the required driving force and the required braking force determined, until the compensation interval time and the subsequent required following time have elapsed.

2. The vehicle control device according to claim 1, wherein
the at least one of the circuit and the processor is configured to determine, using the drive accuracy, the brake accuracy, the driving force range, and the braking force range acquired, the required driving force and the required braking force such that a relationship in which the braking force is greater than the driving force is maintained in terms of the drive accuracy and the brake accuracy, and such that the driving force and the braking force each fall within the driving force range and the braking force range, respectively;
the at least one of the circuit and the processor is further configured to acquire a design time set as a preferable time from start of control for the vehicle start-up until the vehicle actually begins to move; and
the at least one of the circuit and the processor is configured to change, after the elapse of the required following time and until the design time is reached, the driving force required of the drive device and the braking force required of the braking device such that the sum of the driving force, which is a positive value, and the braking force, which is a negative value, transitions to zero in a stepwise manner.

3. The vehicle control device according to claim 2, wherein
when changing, after the elapse of the required following time until the design time is reached, the driving force required of the drive device and the braking force required of the braking device such that the sum of the driving force, which is a positive value, and the braking force, which is a negative value, transitions to zero in a stepwise manner, the at least one of the circuit and the processor is configured to use the drive accuracy and the brake accuracy acquired to change the value on a side with higher realization accuracy among the driving force and the braking force, while maintaining the value on a side with lower realization accuracy.

4. The vehicle control device according to claim 1, wherein
the vehicle control device is usable in a vehicle performing automated driving control for automated parking, and
the at least one of the circuit and the processor is configured to maintain, during vehicle start-up from a temporary stop in front of a parking location toward the parking location in automatic parking, the driving force required of the drive device and the braking force required of the braking device at the required driving force and the required braking force determined, until the compensation interval time and the subsequent required following time have elapsed.

5. A vehicle control method usable in a vehicle performing automated driving control, the vehicle control method being executed by at least one processor, the vehicle control method comprising:
controlling a driving force generated by a drive device of the vehicle and a braking force generated by a braking device of the vehicle;
acquiring performance information regarding performance of the vehicle, the performance information including
a drive response delay time, which is a response delay time of the drive device to a request for power,
a brake response delay time, which is a response delay time of the braking device to the request for power,
a drive accuracy, which is a realization accuracy of the drive device with respect to the request for power,
a brake accuracy, which is a realization accuracy of the braking device with respect to the request for power,
a driving force range, which is a range of the driving force in which the drive device can reflect the request for power with a specified accuracy or higher,
a braking force range, which is a range of the braking force in which the braking device can reflect the request for power with a specified accuracy or higher,
a driving force rate, which is an amount of the driving force that the drive device can change per unit time, and
a braking force rate, which is an amount of the braking force that the braking device can change per unit time;
determining, as a compensation interval time, the longer of the acquired drive response delay time and the acquired brake response delay time, the compensation interval time being a time until the drive device and the braking device begin to respond to the request for power;
determining, using the acquired drive accuracy, the acquired brake accuracy, the acquired driving force range, and the acquired braking force range, a required driving force and a required braking force such that a relationship in which the braking force is at least equal to or greater than the driving force is maintained in terms of drive accuracy and brake accuracy, and such that the driving force and the braking force each fall within the driving force range and the braking force range, respectively; and
identifying, using the acquired driving force rate and the acquired braking force rate and the determined required driving force and the determined required braking force, a required following time, which is an estimated time required from start of the response to the request for power until the required driving force and the required braking force are achieved,
wherein
at a time of vehicle start-up, the driving force required of the drive device and the braking force required of the braking device are maintained at the determined required driving force and the determined required braking force, until the compensation interval time and the subsequent required following time have elapsed.
